(19) United States
(12) Patent Application Publication
(10) Pub. No.: US 2005/0157630 A1
(43) Pub. Date: Jul. 21, 2005

(54) Phase change optical recording medium

(75) Inventors: Tung-Ti Yeh, Tainan City (TW); Tsung-Eong Hsieh, Hsinchu City (TW); Han-Ping D. Shieh, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Daxon Technology Inc.

(21) Appl. No.: 11/036,468

(22) Filed: Jan. 14, 2005

(30) Foreign Application Priority Data
Jan. 15, 2004 (TW) 93100996

(51) Int. Cl. G11B 7/24

(52) U.S. Cl. 369/275.2

(57) ABSTRACT

A phase change optical recording medium. A recording layer is formed on a substrate having a plurality of non-metal particles disposed therein uniformly. Consequently, phase change can occur not only in the interface between crystal and amorphous regions, but also the interface between the particles and the amorphous region.

### BACKGROUND

This invention relates to an optical recording medium and in particular to a phase change optical recording medium.

Due to advantage of convenience, low cost and non-contact reading and writing of optical disk, it is used in various applications. Recently, in order to fit requirements of data transferring from satellite and other multimedia, increasing data transferring rate gets more important. In addition, re-writable optical recording media becomes a new tendency recently.

A phase change recording media offers a crystallographic recording layer changed by irradiating the medium with a laser beam during recording, and wherein reading is accomplished by detecting differences in reflectivity between the recorded area and the unrecorded area.

During recording, the recording layer is irradiated by a high power and short pulse laser beam to form a non-crystal mark at the irradiated region. In erasure of the recorded mark, the recording layer is irradiated by a laser beam with suitable power and longer pulse to change back to crystallization state. Accordingly, the medium can be overwritten by modulating the irradiation intensity of a laser beam (single light beam).

Various attempts have been made to increase density of information being recorded per unit area (higher recording density) and/or to increase transfer rate of the information per unit rate (higher transfer rate) by reducing the recording/reading wavelength, increasing numerical aperture of the objective lens used in the recording/reading optical system, and increasing the linear velocity of the optical recording medium. These attempts, however, have difficulty in practice, such as high cost of short wave length laser apparatus, and focusing and groove searching issue of high NA lens. Increase of liner velocity requires suitable recording materials and layers.

FIG. 1 shows the phase transformation of a eutectic Sb—Te phase change material (fast-growth material) from an amorphous to a crystalline state. As illustrated in FIG. 1, the recrystallization of a phase change layer is initiated from the interface 106 between an amorphous recording mark 102 and a crystalline region 104. During erasure, the recording mark 102 shrinks as the grain growth propagates toward the center of the recording mark 102. Accordingly, recrystall.ization rate depends on the size of the recording mark 102 at the same erasure condition. That means that recrystallization rate is higher if the recording mark 102 is small.

### SUMMARY

Embodiments of the invention provide a eutectic GeInSbTe-(N) phase change recording medium, in which a recording layer is formed on a substrate. The recording layer includes a plurality of non-metal particles disposed therein uniformly. Consequently, phase transformation occurs not only in the interface 106 between crystal and amorphous regions, but also between the non-metal particles and the amorphous region, reducing time and shortening the distance required for phase transition.

Also provided is an erasure method for a eutectic Sb—Te phase change optical recording medium. A recording medium comprising at least an eutectic Sb—Te phase change recording layer is provided, the recording layer doped with a plurality of non-metal particles. The recorded mark is erased by laser, generating phase transformation in the interfaces between the amorphous region and the crystalline region, and between the non-metal particles and the amorphous region, converting the amorphous region to a crystalline state.

### BRIEF DESCRIPTION OF THE DRAWINGS

The present invention can be more fully understood by reading the subsequent detailed description and examples with references made to the accompanying drawings, wherein:

FIG. 1 shows an eutectic Sb—Te phase change mode offast-growth material.

FIG. 2 shows a phase change optical recording medium of an embodiment of the invention.

FIG. 3 is a plan view of a recording layer of an embodiment of the invention.

FIG. 4 shows an exemplary example N000 written 8T signals at liner velocity of 7 m/s.

FIG. 5 shows the example of FIG. 4 after erasure of marks at linear velocity of 7 m/s.

FIG. 6 shows an exemplary example N030 written 8T signals at liner velocity 10.5 m/s.

FIG. 7 shows the example of FIG. 6 after erasure of marks at linear velocity 10.5 m/s.

FIG. 8 shows a structure of a phase change optical recording medium of an embodiment of the invention, applied in a CD-RW.

FIG. 9 shows a structure of a phase change optical recording medium of an embodiment of the invention, applied in a DVR.

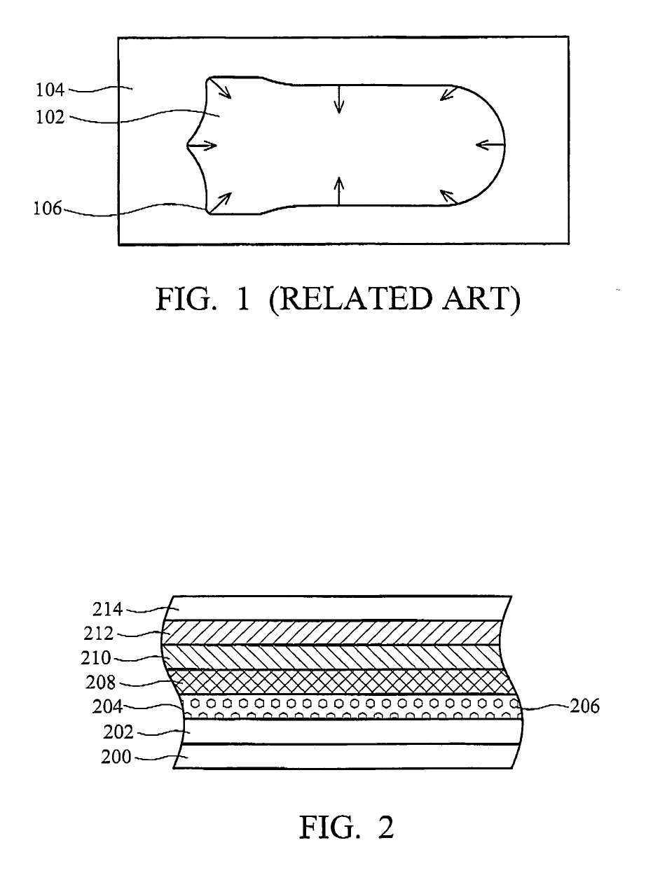

### DETAILED DESCRIPTION

FIG. 2 shows an eutectic GeInSbTe-(N) phase change optical recording medium of an embodiment of the invention, using a DVD-RW as an example. A first dielectric layer 202 is formed on a substrate 200 by sputtering. The first dielectric layer 202 comprises SiN₄, AlN, SiO₂, Tao, ZnS, MnS, ZnSe or the combination thereof with preferred thickness of 1 nm˜100 nm. Preferably the substrate 200 is a transparent substrate and more preferably comprises polycarbonate resin. The first dielectric layer 202 acts as a heat-retaining layer to reduce heat loss during writing or erasing Next, a recording layer 204 doped with uniform non-metal particles 206 is formed upon the first dielectric layer 202. The non-metal particles 206 comprise dielectric or ceramic materials, providing thermal stability. Preferably, the non-metal particles comprise SiO_{X}, SiO_{X}N_{y}, AlN, Al2O3, TiN, AlTiN, TiO₂, Ta₂O₅, GaAs, GaInAs, Fe₂O₃, Fe₃O₄, Bi₂NX, Bi₂O₃, BiNx, CaF₂, CaO, CdO, Cd₂O₃, CdS, CeO₂, CeF₂, CsBr, CsI, InAs, InSb, In₂O₂, KBr, KCl, LaF₃, La₂O₃, LiF, MgO, MgF₂, NaF, Nd₂O₃, NdF, NdF₃, PtO₂, Sb₂O₃, Sb₂S₃, SiC, PbCl₂, PbF₂, PbS, or PbTe.

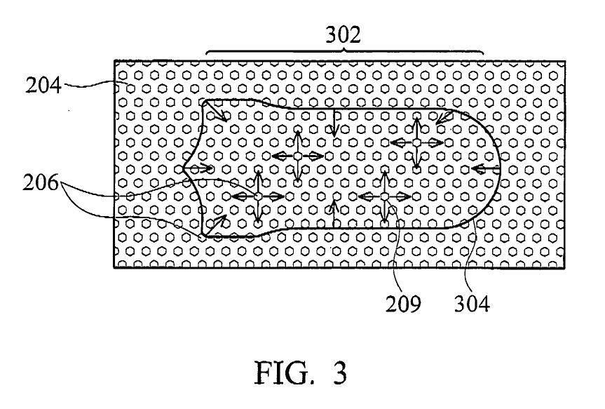

The size and characteristics of the non-metal particles 206 remain unchanged after annealing or irradiated by a laser beam. FIG. 3 is a plan view of the recording layer 204 doped with non-metal particles 206. The non-metal particles 206 can be ball-shaped, silk-shaped or any other, but must be disposed uniformly in the recording layer 204 to avoid noise during reading of the recording medium. The center cross-section area of the non-metal particles 206 is preferably less than 1/100 of the smallest recording marks. Reading signals are affected if the non-metal particles 206 are too large. Preferably the diameter of the non-metal particles 206 is 0.1˜30 nm.

The recording layer 204 is recrystallized when irradiated by laser, converting from an amorphous to a crystalline state. The non-metal particles 206 disposed uniformly in the recording layer 204 promote recrystallization occurring not only in the interface 304 between the amorphous region and the crystalline region, but also in the interface 209 between the non-metal particles and the amorphous region, thus reducing phase change duration. The recording layer 204 comprises an amorphous region and a crystalline region. Recrystallization of the recording layer occurs in both the interface 304 between the amorphous region and the crystalline region, but also in the crystalline region.

Preferably the recording layer 204 doped with non-metal particles 206 is formed by reactive sputtering, in which Ar and small amounts of N₂ are introduced into a chamber. During processing, a target in the chamber is sputtered by Ar⁺ to generate metal ions, reacting with nitrogen ion to form non-metal particles in the recording layer. Size and density of the non-metal particles 206 are controlled by adjusting N₂/Ar ratio or sputtering power. The preferred mixing percentage of N₂ in Ar is 0.1%˜5%. In addition, non-metal particles 206 can also be formed by introducing Ar and small amounts of O₂ into the chamber.

Formation of the recording layer 204 doped with non-metal particles 206 can also be formed by multi-target sputtering, in which at least two targets are disposed in a chamber, the first target comprises phase changing materials and the second target comprises ceramic materials. Next, Ar gas is introduced into the chamber, sputtering the first and second targets. The recording layer 204 is deposited by sputtering the first target with non-metal particles 206 doped into the recording layer 204 by sputtering the second target. Size and density of the non-metal particles 206 are controlled by adjusting Ar flow rate, the magnet, or sputtering power.

As shown in FIG. 2, a second dielectric layer 208 is formed upon the recording layer 204. The second dielectric layer 208 comprises SiN₄, AlN, SiO₂, Tao, ZnS, MnS, ZnSe or combination thereof at preferred thickness of 1˜100 nm. The function of the second dielectric layer 208 is similar to the first dielectric layer 202, reducing heat loss during writing or erasing.

A reflective layer 210 is formed on the second dielectric layer 208, preferably comprising metals with high reflectivity, such as Al, Ag or Au, at a thickness of 10-200 nm. Finally, a resin layer 212 is applied, and a substrate 214 bonded thereon, thus protecting the layers described from being corroded or oxidized by ambient moisture.

In FIG. 3, an erasure method of an eutectic GeInSbTe-(N) phase change optical medium of embodiments of the invention comprises a recording medium with a recording layer 204 being provided, then doped with a plurality of non-metal particles 206, the recording layer 204 comprises an amorphous region and a crystalline region. The recording layer is irradiated by a laser beam. Phase change occurs in the amorphous region, converting the amorphous state of the amorphous region to a crystalline state, wherein phase transformation occurs not only in the interface 304 of the crystalline region and the amorphous region, but also in the interface 209 between the non-metal particles and the amorphous region.

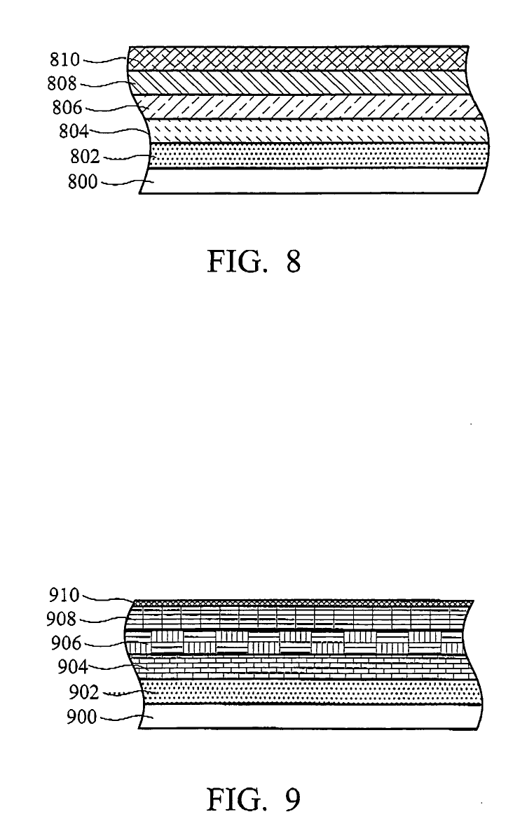

While a DVD-RW is used as an exemplary application of the invention, the disclosure is not limited thereto, with any recording medium with phase change recording layer doped with non-metal particles, such as CD-RW or DVR also suitable. As shown in FIG. 8, a CD-RW comprises a substrate 800, a first dielectric layer 802, a recording layer 804, a second dielectric layer 806, a reflective layer 808 and a protective layer 810. In FIG. 9, a DVR comprises a substrate 900, a reflective layer 902, a first dielectric layer 904, a recording layer 906, a second dielectric layer 908 and a light transmittance layer 910, wherein the light transmittance layer 910 preferably has a thickness of 0.01˜0.5 mm for reduced light interference.

Experimental results and process steps, using a DVD-RW as an example follow is described below. A first dielectric layer 202 is formed of ZnS-SiO₂, the recording layer 204 is formed of GeInSbTe, a second dielectric layer 208 is formed of ZnS-SiO2, and a reflective layer 210 is formed of Al—Cr. Thicknesses of the substrate 200, the first dielectric layer 202, the recording layer 204, the second dielectric layer 208 and the reflective layer 210 are substantially 0.6 mm, 55 nm, 16 nm, 11 nm and 133 nm. A substrate 214, having a thickness of 0.6 mm, is bonded thereon using a resin. Table 1 shows sputtering conditions and composition of targets for forming the recording layer 204. Samples in Table 1 is written 8T digital signals using a dynamic testing apparatus, comprising a laser with wavelength of 660 nm and a lens with a numerical aperture of 0.6, with suitable write/erase ratio after initializing, and are erased to detect a DC erasability. High DC erasability is directed to high phase transformation rate from an amorphous state to a crystalline state and/or data transfer rate of optical recording medium. The DC erasability is over 25 db to enable direct overwriting. Table 2 shows the DC erasability of all samples, with phase transformation rate effectively increased when N₂/Ar ratio is less than 5%.

TABLE 1

| Sam- | N₂ flow | Ar flow | N₂/Ar | | pressure | Power |
|---|---|---|---|---|---|---|
| ple | (sccm) | (sccm) | ratio | Target | (mTorr) | (W) |
| | 0 | 10 | 0 | ZnS—SiO2 | 3 | 250 (RF) |
| | 0 | 10 | 0 | Al—Cr | 3 | 400 (DC) |
| N000 | 0 | 10 | 0 | GeInSbTe | 3 | 50 (RF) |
| N005 | 0.05 | 10 | 0.50% | GeInSbTe | 3 | 50 (RF) |
| N010 | 0.1 | 10 | 1.00% | GeInSbTe | 3 | 50 (RF) |
| N030 | 0.3 | 10 | 3.00% | GeInSbTe | 3 | 50 (RF) |
| N050 | 0.5 | 10 | 5.00% | GeInSbTe | 3 | 50 (RF) |
| N100 | 1 | 10 | 10.00% | GeInSbTe | 3 | 50 (RF) |

TABLE 2
Erasability

| | Data transferring rate | | | | |
|---|---|---|---|---|---|
| | 11.08 | 16.62 | 22.16 | 27.70 | 33.24 |
| | Mbps | Mbps | Mbps | Mbps | Mbps |
| | liner speed | | | | |
| | 3.5 m/s | 5.3 m/s | 7.0 m/s | 8.8 m/s | 10.5 m/s |
| N000 | 39.89 | 28.03 | 12.38* | x | x |
| N005 | 48.59 | 43.86 | 34.36 | 16.58* | x |
| N010 | 37.17 | 48.81 | 42 | 17.28 | x |
| N030 | 36.75 | 40.36 | 42.34 | 26 | 16.91 |
| N050 | x | x | x | x | x |
| N100 | x | x | x | x | x |

*erasing rate insufficient for direct rewriting.
x erase failure

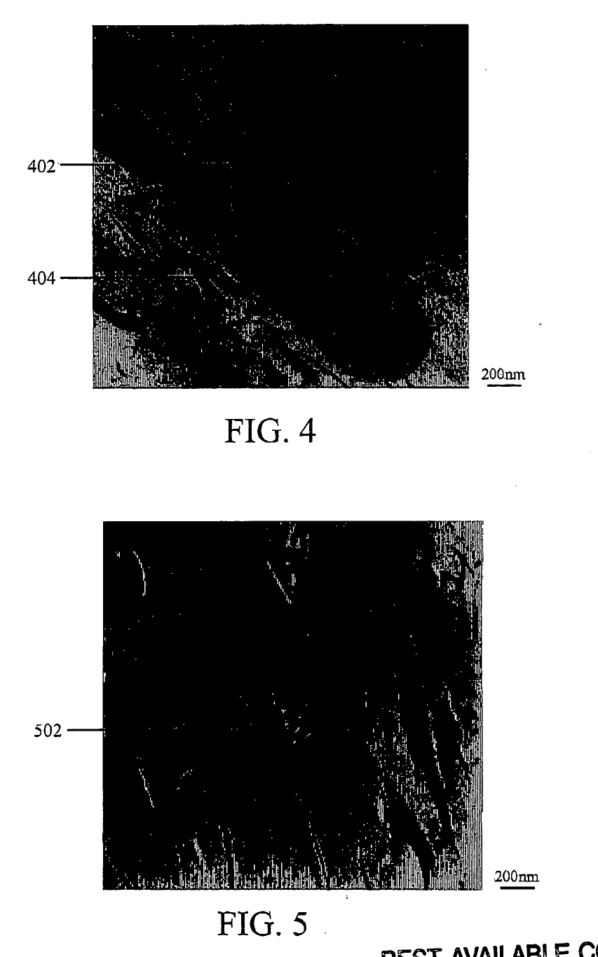

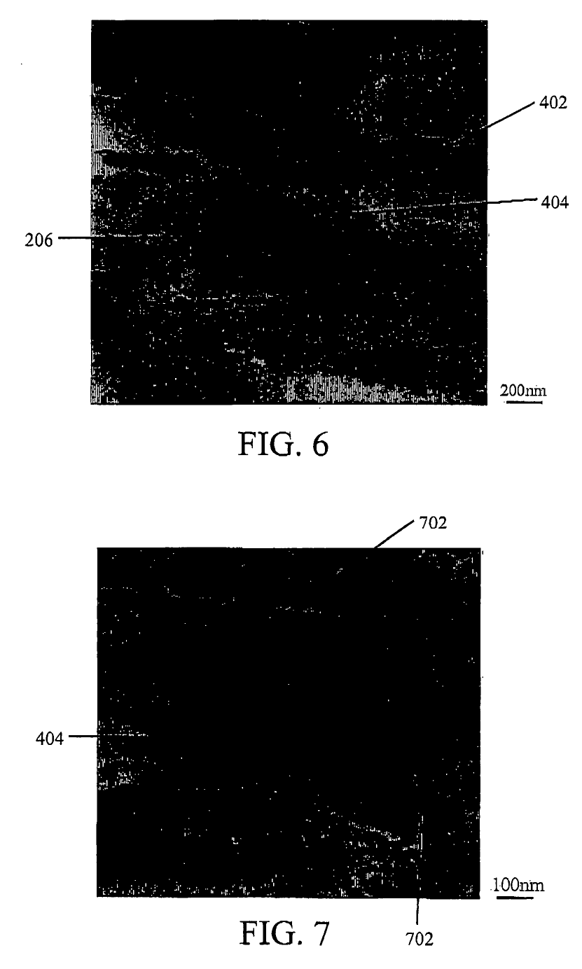

Samples of N000 and N030 are further examined by TEM, in which the microstructures are shown in FIGS. 4-7. FIG. 4 shows the sample N000 written 8T signals at 7 m/s liner velocity. FIG. 5 shows the example of FIG. 4 after erasure of the marks at linear velocity of 7 m/s. FIG. 6 shows the sample N030 written 8T signals at 10.5 m/s liner velocity. FIG. 7 shows the sample of FIG. 6 after erasure of the marks at linear velocity of 10.5 m/s. As illustrated in FIG. 4, the crystalline region 402 of sample N000 is a typical column structure, with a recorded mark 404 in the recording layer. FIG. 5 indicates an erased recorded mark 502, with phase change mode of the amorphous recording mark similar with that of typical fast growth materials. As illustrated in FIG. 6, a plurality of white particles 206 are disposed uniformly in the amorphous recorded mark 404, and the erased recorded mark 702 is shown in FIG. 7. Recrystallization occurs not only in the interface between the amorphous region and the crystalline region, but also in the interface 702 between the particles and the amorphous region, thus increasing phase changing rate. Consequently, re-write speed is increased, satisfying requirements of high recording medium.

While the invention has been described by way of example and in terms of the preferred embodiments, it is to be understood that the invention is not limited. To the contrary, it is intended to cover various modifications and similar arrangements (as would be apparent to those skilled in the art). Therefore, the scope of thee appended claims should be accorded the broadest interpretation so as to encompass all such modifications and similar arrangements.

1. A phase change optical recording medium, comprising:
a substrate; and
a recording layer disposed over the substrate, comprising a plurality of non-metal particles.

2. The phase change optical recording medium as claimed in claim 1, wherein the particles comprise ceramic materials.

3. The phase change optical recording medium as claimed in claim 1, wherein the particles comprise dielectric materials.

4. The phase change optical recording medium as claimed in claim 1, wherein the center cross section area of the nonoparticles is smaller than 1/100 of a smallest recording mark of the phase change optical recording medium.

5. The phase change optical recording medium as claimed in claim 1, wherein the particles have a diameter of 0.1˜30 nm.

6. The phase change optical recording medium as claimed in claim 1, further comprising:
a first dielectric layer disposed overlying the substrate, wherein the recording layer is disposed overlying the first dielectric layer; and
a second dielectric layer disposed overlying the recording layer.

7. The phase change optical recording medium as claimed in claim 1, further comprising a reflecting layer disposed overlying the second dielectric layer.

8. The phase change optical recording medium as claimed in claim 1, further comprising a protective layer disposed overlying the reflective layer.

9. The phase change optical recording medium as claimed in claim 7, further comprising a resin layer disposed overlying the reflecting layer, and a substrate disposed overlying the resin layer.

10. The phase change optical recording medium as claimed in claim 6, further comprising a reflecting layer interposed between the substrate and the first dielectric layer, and a light transmittance layer disposed on the second dielectric layer.

11. The phase change optical recording medium as claimed in claim 1, wherein phase change occurs when the phase change optical recording medium is irradiated by a laser, converting the recording layer from a amorphous state into a crystalline state, the recording layer comprises an amorphous region and a crystalline region, wherein the crystallization occurs not only in the interface between the amorphous region and the crystalline region, but also in the amorphous region.

12. A method for forming a phase change optical recording medium, comprising:
providing a substrate; and
forming a recording layer over the substrate with a plurality of non-metal particles formed therein.

13. The method as claimed in claim 12, wherein the recording layer is formed by introducing Ar and N₂ into a chamber and sputtering a target in the chamber.

14. The method as claimed in claim 13, wherein N₂/Ar mixing percentage is 0.1%˜5%.

15. The method as claimed in claim 12, wherein the recording layer is formed with a plurality of non-metal particles by introducing Ar into a chamber and sputtering a plurality of targets with Ar in the chamber.

16. The method as claimed in claim 15, wherein the targets comprise a phase changing material and a ceramic material.

17. An erasure method of a phase change optical recording medium, comprising:
providing a recording medium comprising at least a recording layer, doped with a plurality of non-metal particles; and
irradiating the recording medium with a laser, wherein phase change occurs both in the interface between an amorphous region and a crystalline region in the recording layer, and in the interface between the particles and the amorphous region, converting the amorphous region to a crystalline state.
